(19) United States
(12) Patent Application Publication
(10) Pub. No.: US 2007/0129967 A1
(43) Pub. Date: Jun. 7, 2007

(54) Automated method for medical care management

(76) Inventors: Stephen Carter Thompson, Chatham, VA (US); Girard V. Thompson III, New Freedom, PA (US)

Correspondence Address: WOODS, ROGERS, P.L.C., 1505 LONDON ROAD, CHARLOTTESVILLE, VA, 22902-8681, US

(21) Appl. No.: 11/293,996

(22) Filed: Dec. 5, 2005

(51) Int. Cl. G06Q 10/00; G05B 19/418

(52) U.S. Cl. 705/2; 705/8

(57) ABSTRACT

A computer-assisted method for diagnosing and treating illnesses and health complaints in patients in which diagnosis is performed by following processes specified in one or more diagnostic templates and treatment occurs pursuant to processes specified in one or more treatment templates. Both types of templates include processes related to selected sets of illnesses and health conditions. Use of the method changes the focus in healthcare delivery from one which is encounter-centric to one which is problem-centric by organizing patient records around the processes used to diagnose and treat health problems. The method also provides enhanced administrative ability to monitor, coordinate and manage these processes along with healthcare resources.

### TECHNICAL FIELD

The subject invention relates generally to the field of medical systems and methods utilizing a database application for assisting with the management and monitoring of patient care. More particularly, this invention concerns an automated method for collecting medical process metrics in the background while aiding the system user in the foreground with problem-focused medical process definition and execution guidance, staff and resource management, process configuration and improvement, medical data entry and medical data processing tools.

### BACKGROUND OF THE INVENTION

Healthcare is currently undergoing changes that will have a tremendous impact on the access patients will have to and the role physicians will have within the healthcare delivery system of the future. Individual patient physician encounters currently form the basic structure through which healthcare is delivered today. These encounters are based on a private consultative format through which physicians diagnose and treat patient's problems or concerns. Physicians are also responsible for most patient education within these interactions. The patient-physician interaction is the most fundamental transaction within healthcare delivery and determines both the cost and quality of care the patient receives.

Today's clinical data management systems have been developed to support the patient encounter format for healthcare delivery. Medical data collection focuses on gathering information primarily to describe the patient physician encounter for the purpose of determining an appropriate charge for billing. These data systems collect various types of patient medical information and the databases generally store this information based on the data type. For instance, laboratory data is collected and stored based on the specific lab type. Encounter documentation does collate some of this data in an attempt to give the data some structure, but does so for the primary purpose of illustrating what occurred during an encounter, not to demonstrate the diagnosis or treatment of a patient's concern. Some medical management systems have been able to incorporate views which do gather and display data based on certain disease types, but the general structure of these data systems still focuses on the patient-physician encounter.

The quality of patient care is dependant on the ability of providers to glean an accurate representation of the history and current state of a particular medical problem by reviewing documentation of individual patient encounters. Specific diagnostic and treatment tasks are buried within this data structure and make it difficult to obtain a clear and comprehensive understanding of the patient's medical history with respect to the patient's medical diagnoses and treatments. Advances have been made which allow different views of the existing data, sometimes in relation to specific disease entities, but more often these views show temporal relationships of similar data types. Most of the relevant data regarding the diagnoses and treatments patients receive in relation to their complaints or diagnoses are contained within the encounter note structure and require providers to review these notes in order to determine the current state of a problem or concern. There is also little support for decisions regarding future interventions or assessments for specific disease entities.

With the focus being the patient encounter, there exists a need both for the provider to monitor care processes within the practice and for a method to facilitate quality improvement. Most medical data management systems provide methods for monitoring data points that are secondary indicators of quality of care, but they do not provide adequate methods of data collection that look at how care is actually delivered.

Healthcare delivery is a highly procedural entity, most of which can be generalized into either diagnostic or treatment processes. In order for healthcare delivery to become more effective and efficient, it is necessary to primarily affect how these essential processes are carried out. Information technology is currently being touted as healthcare's best hope for becoming efficient in the future, but this outcome depends on how this technology will influence these basic processes of healthcare.

In order to obtain some control over the cost of healthcare, cost controls will need to be placed back within the patient physician relationship. The system that provides the best results in this regard is a purely capitated rate system in which every patient pays a set amount for healthcare. Healthcare is currently based primarily on the individual patient-physician encounter which was developed within a fee for service system. If the basis of healthcare were changed to focus on the process of diagnosis and treatment, then providers would be in a system in which they would be able to respond to a reimbursement environment that is more like a capitated system and remain profitable. If physicians were paid more only if they efficiently provided more quality care, then this model would have a rapid and dramatic effect on the overall cost of healthcare.

What is needed is a medical data and management system that focuses on the fundamental processes of patient care and provides for the continual improvement of those processes. Such a system would empower patients and provide them with a better understanding of their health problems while also utilizing providers and staff more efficiently so as to improve the overall quality of care delivered.

### SUMMARY OF THE INVENTION

This invention relates to an interactive, computer-assisted method for collecting, organizing, supervising and analyzing data concerning patient medical care so as to assist health care providers in making medical diagnoses and selecting and implementing appropriate treatments. The method involves creating diagnostic and treatment templates comprised of a series of processes which templates are interlinked. When a patient presents at a health care facility with a complaint, at least one medical project is initiated on behalf of that patient. After collecting information concerning the patient, the patient's complaint is associated with one or more of the diagnostic templates which is then, in turn, linked to at least one medical project associated with that patient. After at least one diagnosis has been established by completing the processes associated with at least one diagnostic template, at least one treatment template is selected and linked with each diagnosis associated with the specific patient. Each treatment template is then further linked with at least one medical project associated with the specific patient. After either all of the processes in a specific treatment template are completed and the patient's condition is resolved or has evolved into a manageable chronic condition or after the need to refer the patient to another medical facility is recognized, the method is completed.

### BRIEF DESCRIPTION OF THE DRAWINGS

The foregoing and other objects, aspects and advantages of the invention will be better understood from the following detailed description of the invention with reference to the drawings, in which

FIG. 1 presents in block diagram form a general view of the method of this invention.

FIG. 2 presents in block diagram form the template creation and linking process of this invention.

FIG. 3 presents in block diagram form the functions of the process management interface portion of this invention.

FIG. 4 presents in block diagram form the diagnostic process of this invention.

FIG. 5 presents in block diagram form the treatment process of this invention.

### DETAILED DESCRIPTION OF THE INVENTION

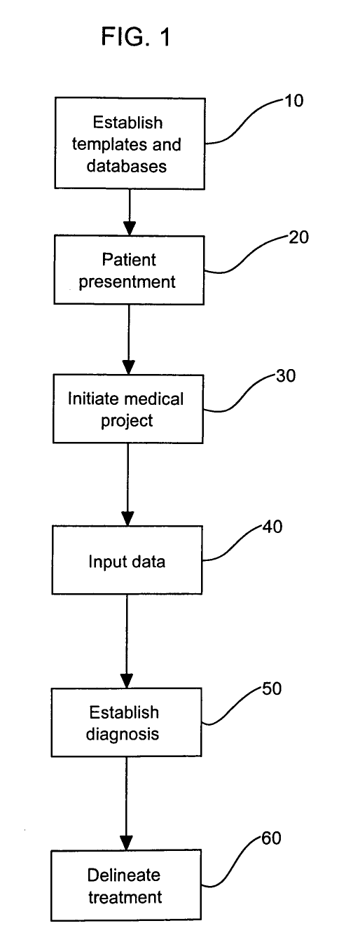

For a more detailed understanding of the invention, reference is first made to FIG. 1 of the drawings in which a general overview of the method of the invention is illustrated in block diagram form. At 10, recognized medical diagnostic and treatment processes for all known diseases and medical conditions or any desired or known subset of such diseases and medical conditions are transformed into interactive templates and entered into at least one computer database. Similarly, medical diagnoses are also separately entered into at least one computer database. Each treatment process is then linked to at least one diagnosis and each diagnostic process is linked to at least one diagnosis. The relationship between diagnoses, diagnostic processes and treatment processes is that one diagnostic process could lead to one of several different diagnoses and, consequently, different treatment processes, while different diagnostic templates could lead to the same diagnosis. Thereafter, at 20, a patient presents with a medical problem or concern and is provided access through a computer to these templates. Such presentment may occur either electronically through a terminal located remotely away from or at a medical facility, through an Internet connection or may result from the physical presence of the patient who has a scheduled appointment at a medical facility. At 30, the computer system which manages execution of the method of this invention establishes a blank new medical project linked to this patient. At 40, the patient provides data to the system which may either be initial identifying and background information or information updating and verifying data concerning that patient which is already in the system. Typically, such data also includes demographic information which may ultimately prove important in the choice of treatment. By entering data in this manner, the involvement time of a physician at this stage of the process is minimized thereby increasing efficiency and reducing costs. All data provided is stored in a database storage device connected to the computer responsible for managing the method of this invention. The computer is capable of accepting multiple methods of data entry including dictated notes, standard word document formats including, but not limited to, .pdf, .doc and .ect, audio recordings, as well as digital photographs in formats including, but not limited to, .gif, mpeg, jpeg and tiff. In addition, the system will accept real time input from medical devices such as stethoscopes, electronic EKG's, digital radiographs and video recordings. If data is provided electronically, the patient accesses the managing computer through a secure, password-protected, personal medical account (PMA) uniquely established and linked to each patient. If a patient desires a physical visit to the health care provider, an appointment may be requested through the PMA or by otherwise contacting the provider, such as by telephone. A diagnosis is then made through a partially automated process at 50. Once the diagnosis is finalized, the patient progresses through the automated treatment process at 60 until the desired outcome is achieved or referral to another medical treatment facility is necessitated.

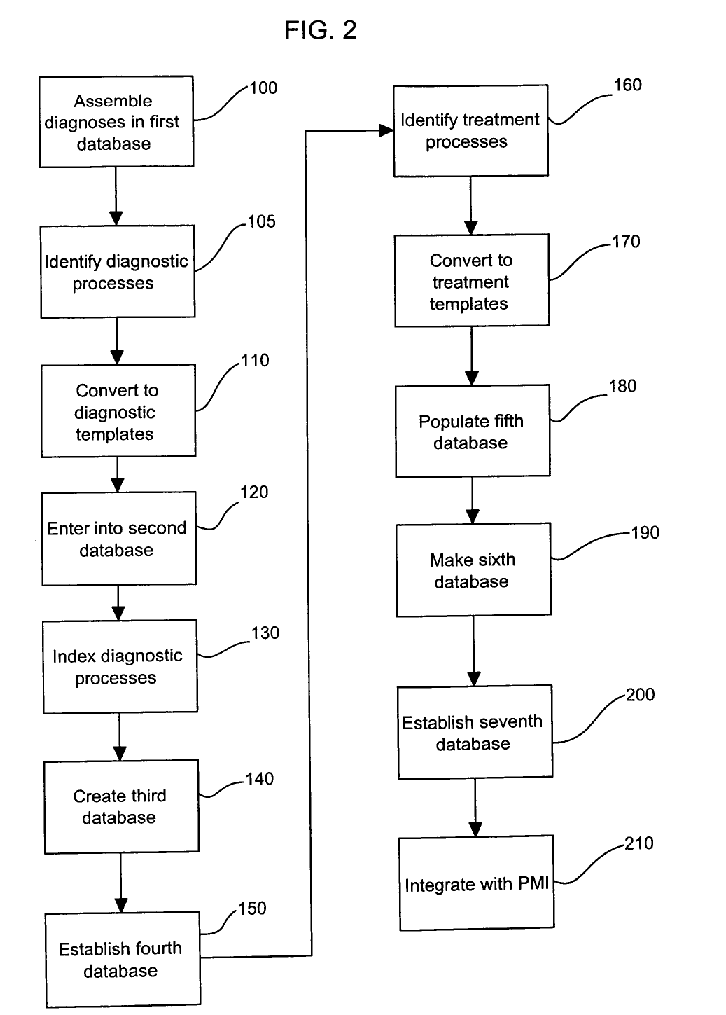

FIG. 2 illustrates in block diagram form the template creation and linking process referred to at 10. Initially, a plurality of diagnoses related to one or more medical conditions are identified and stored in at least one first database at 100. Then, a plurality of diagnostic processes related to one or more medical conditions are identified at 105. Each process comprises an interlinked series of events including, but not limited to, activities, questions, instructions, pre-designated decision points, actual data and requests for data. One diagnostic process may be linked to one or more other diagnostic processes so that two or more diagnostic processes may be interwoven. Each process or medical project can have multiple strings, or execution paths running simultaneously within that process or project. Multiple parties can be working on the same project simultaneously making assessments, inputting data elements or other interactions with the project. Also, there can be relationships between different processes or projects. One type of relationship is that a diagnostic process can be derived from another diagnostic process. For example a patient presents with diabetes and during that work up it is determined that the patient also has chest pain, this would lead to a separate diagnostic pathway and then possibly the diagnosis of CAD and then to treatment. Two diagnostic processes can converge into one if two complaints are being evaluated and then one diagnosis explains both. A relationship can exist within diagnostic processes that are interrelated making it important to identify and maintain the relationship until it can be examined and a diagnosis is determined. Also, certain items within separate diagnostic pathways may be shared. All processes are converted into standard diagnosis templates at 110. Processes comprised within templates are created in several ways. They can be created through a process creation interface (creating a baseline diagnostic or treatment process for well established circumstances), or they can be created from data collected as patient care activities are performed for given symptoms or diagnoses and the results are recorded. These recorded activities are then reviewed and templates can be created from such data, if appropriate. Established processes are monitored for variation and when successful variations exist, then templates can be updated or a newer version can be created. All diagnostic processes are entered into at least one second database accessible by the computer at 120. Entry may be accomplished manually or in an automated fashion. Each such process is further indexed at 130 to one or more words and phrases appearing in one or more medical terminology databases such as, but not limited to ICD-9, and/or in one or more common language databases. The resulting index is used to create at least one third database accessible by the computer at 140. At least one fourth database is established at 150 which is meant to be populated by blank diagnostic process templates. Such blank templates are activated, as described below, when none of the diagnostic processes in the first database is found specifically applicable to a patient's medical complaint and a new diagnostic process must be developed. At 160, a plurality of treatment processes related to one or more of the diagnoses in the first database are identified. Each treatment process comprises an interlinked series of activities, questions, instructions, pre-designated decision points, actual data and requests for data. In a manner similar to diagnostic processes, one treatment process may be linked to one or more other treatment processes so that two or more treatment processes may be interwoven. However, a treatment process may also reenter the original diagnostic pathway which led to the treatment in the event it was determined to be inaccurate, or it may lead to other diagnostic pathways if new symptoms arise. These diagnostic projects may be a subset of the original treatment process, especially if it was the result of an adverse event arising from treatment or complication of the disease. Adverse events or complications would be a branch point, associated with the original treatment process in that fashion. The new diagnostic process may also be unassociated with the original diagnosis or treatment and therefore would not be directly associated with the original treatment process. The provider determines these relationships, but even if it was thought that no relationship existed then a ‘not thought to be related’ relationship within the data structure would exist to aid in review at a later date to pick up subtle relationships that may not be immediately recognized. These relationships can be viewed later at a system level to see if unexpected complications or adverse events are occurring and then appropriate interventions may be undertaken. All treatment processes are converted into standard treatment templates at 170 and are entered into at least one fifth database accessible by the computer at 180. Entry may be accomplished manually or in an automated fashion. At least one sixth database is established at 190 which is meant to be populated by blank treatment process templates. Such blank templates are activated, as described below, when none of the standard treatment processes in the fifth database is found specifically applicable to a patient's medical complaint and a new treatment process must be developed. The diagnostic and treatment processes in the second and fifth databases are denominated as templates since, as discussed below, all templates are interactive and subject to modification, addition and deletion. Finally, at least one seventh database is set up at 200 for storing and tracking medical projects relating to all patients. This latter database library organizes medical projects for use in the clinical setting according to process management tools or higher level management functions. It catalogues all medical projects and different versions of those projects including both those which have been executed and those which have been subsequently edited. It maintains all data related to medical projects available for execution and organizes them to assist in their selection and use in a clinical setting. All of the databases are then integrated at 210 with a process management interface (PMI) which is an interactive computer program performing managerial, access control, data entry, data transfer, data tracking and supervisory functions.

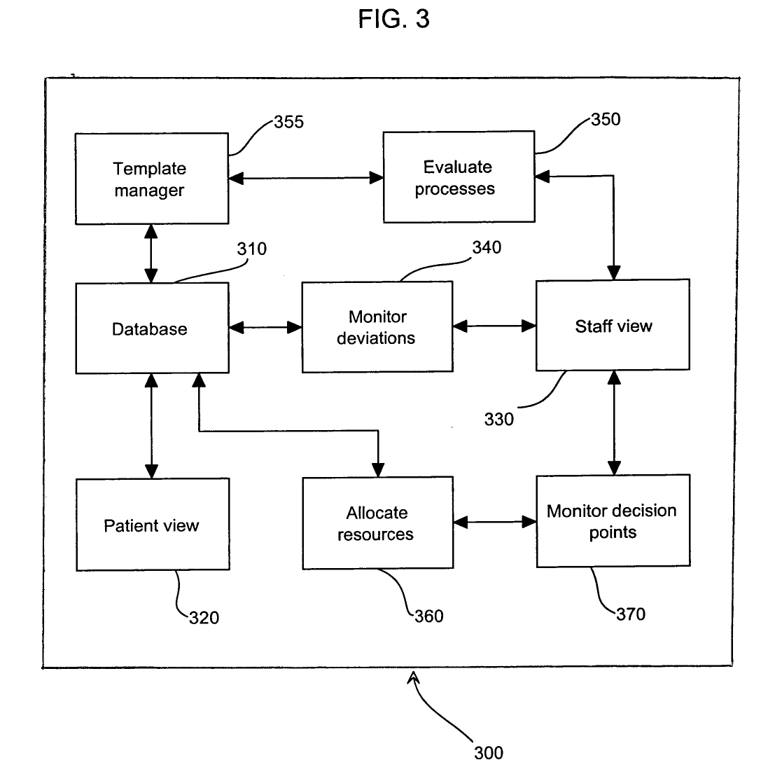

The functions performed by the PMI are illustrated in block diagram form in FIG. 3. PMI 300 is a software program comprised of multiple, interlinked, multi-threaded modules. The multi-threaded nature of the PMI permits simultaneous interactions within the process structure. Consequently, synchronization of multiple process inputs and activities as well as synchronization of multiple processes within a medical project is possible. Module 310 provides access to data stored in the seven databases discussed above. Module 320 enables patients through their PMA to electively view the process template applicable to the diagnosis of the patient's medical complaint, the current status of the diagnosis, the proposed treatment plan, once a diagnosis has been made, the current status of a treatment plan, a list of relevant educational materials and Internet or other computer links to such materials. Except in specified circumstances, the patient has unrestricted access to medical data within their medical project. Exceptions include situations such as diagnoses associated with poor prognoses, such as cancer, or with public health consequences, such as HIV, in which cases personal counseling would be required and access to information would be restricted. Another exception is diagnoses in which the patient might react unpredictably, such as psychiatric patients. Module 330 provides a staff view enabling authorized persons to access, view, analyze and edit data in all of the other modules in the PMI. More particularly, properly authorized physicians, nurses and administrative personnel may view any data in module 310 concerning a patient or a medical project including, but not limited to patient data entries, patient medical history, patient complaint items and activities relating to any diagnostic or treatment template. Each type of staff member has a different level of authorized access. These levels of access can be defined at the user level because different office environments will have different staff arrangements. For example, a physician would have access to all elements of the medical record but a secretary may just have access to demographic, billing and scheduling data. This information is accessible as it relates to in-process, completed and future activities. Through the staff view, three basic types of item entries can be made: data, action or basis. Data items include any patient assessments or other data elements such as laboratory reports. Action items include any task relating to patient care, while basis items document the reasoning and rationale behind decisions made during patient care. Physicians may edit future action items called for by the processes and medical projects stored in module 310 through module 330 by adding, deleting or modifying action items. Such alterations can be designated to apply only to a process as it applies to an individual patient or globally to the same process as it applies to all patients tracked by the system. Thus, use of the PMI eliminates the need for separate physician encounter notes since the course of care is recorded as it is delivered and overall supervision of all patient care processes occurs. Furthermore, the staff view enables staff to intervene in real time to refer the patient for immediate in-person evaluation, if called for, as well as to change any current diagnostic or treatment template, if desired. Properly authorized personnel may also use the staff view to perform the administrative function of converting and transferring blank diagnostic templates after their incorporation into a medical project from the fourth database into standard diagnostic templates included in the second database. Similarly, blank treatment templates from the sixth database may be converted and transferred into standard treatment templates included in the fifth database. Module 340 monitors any deviations from standard processes called for by physician entries overriding processes otherwise mandated by standard diagnostic or treatment templates. Through the staff view, staff may also access module 350 which monitors and evaluates the implementation, effectiveness and outcome of any diagnostic or treatment process called for by an active diagnostic or treatment template on an individual patient basis and globally as it relates to all patients affected by a designated process who are tracked by the system. This module enables comparisons of the effectiveness of all processes and alterations or deletions of processes as more effective processes are encountered. Data can be displayed as it relates to processes or, electively, as it relates to data type. Furthermore, data can be displayed as it relates to a single process, multiple processes or on a global scale. Similarly, data can be displayed as it relates to an individual patient, multiple patients, single templates of either the diagnostic or treatment type or multiple templates, as selected by an authorized user. Module 355 is a template configuration management module which controls which version of any particular diagnostic or treatment template is associated with a particular medical project or projects or should be implemented globally across the system. Module 360 automatically coordinates, schedules and allocates medical resources according to entries made in the respective diagnostic or treatment template for a medical project and notifies affected parties of scheduling or rescheduling of elements of one or more processes. Consequently, where one process or template is linked to one or more other processes or templates, seamless and simultaneous execution of activities called for without the need for human intervention is achieved. Actual data is a component of every process and template and is displayed or made directly available through the PMI to authorized parties. Such displayed data plays an integral part in physician decision making, as discussed below. In addition, as also discussed below, some data points may automatically lead to further actions or data requests. Module 360 is also responsible for integrating other administrative functions into the system such as, but not limited to, billing. Module 370 monitors pre-designated decision points in each medical project and requests input from the relevant staff person when such decision points are encountered. The functions performed by PMI 300 provide a tool to support medical decision making and helps to automate the execution of patient care activities while allowing the physician to retain control over the process. Furthermore, PMI 300 promotes improved efficiency and reliability by providing automated, reusable diagnostic and treatment templates and also results in higher quality health care.

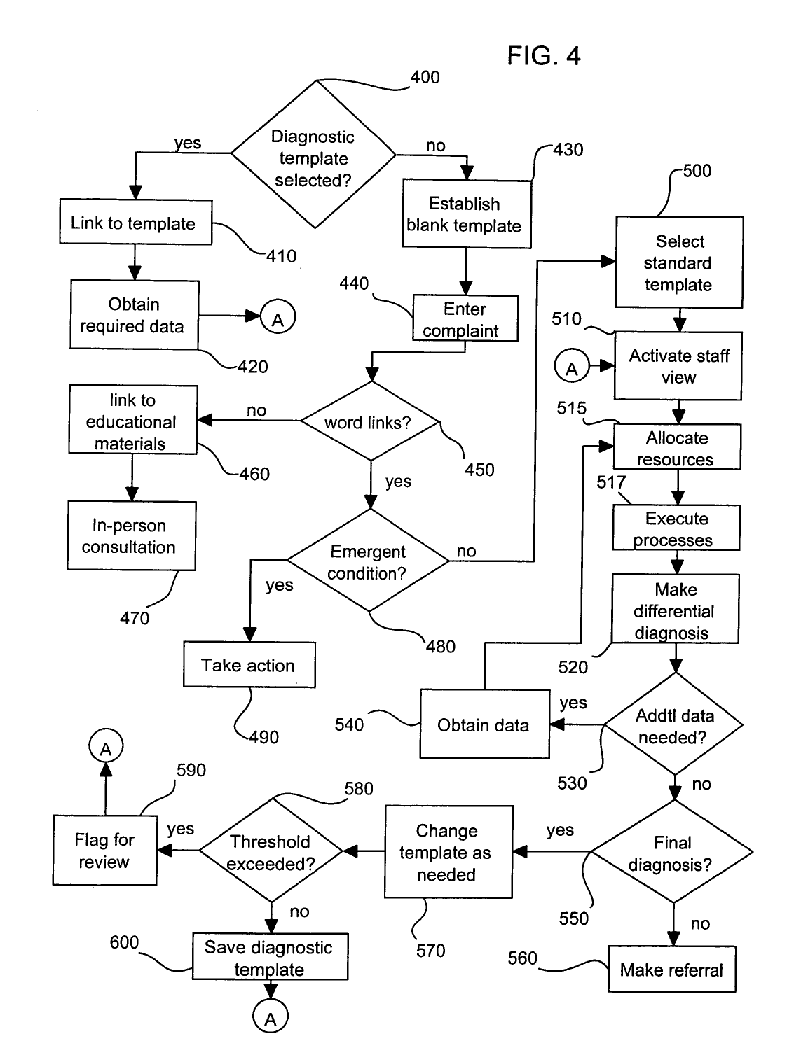

FIG. 4 illustrates in block diagram form the diagnostic process of 50. At 400, the patient is given the opportunity to select from a displayed list of medical conditions each of which is linked to one or more standard diagnostic process templates in the second database relating to that condition. As indicated above, a process is composed of activities linked together by pre-designated decision points, questions, instructions, actual data and requests for data associated with one or more medical conditions. An activity is a task performed by the system user such as creating a report/form, electronic medical record data entry, completing a medical order (such as laboratory, procedure, consultation) or interacting with an external system or software application. An activity can be tagged with one or more user roles (doctor, nurse practitioner, nurse, patient or administrator) designations that determines who is permitted to perform the activity. If the patient makes a selection from the list of conditions, links are established through the PMI at 410 to one or more diagnostic process templates in the second database relating to that problem and to one or more blank medical projects created for that patient in the seventh database. Then, more detailed information from the patient is requested and collected at 420. The patient's selection is then reviewed and verified by a physician at 510, as described more fully below. If no displayed selection is relevant, a blank template is established in the fourth database for the condition at 430, and the patient enters a textual description of the medically-related complaint at 440 which is then also linked to one or more newly established medical projects created for that patient in the seventh database. The system monitors all of the entries made by the patient, parses these entries and compares them to the contents of the third database at 450 to seek one or more matches. This third database incorporates ICD-9 and other medical terminology as well as common word databases. If no matches occur, the PMI directs the patient at 460 to such educational materials as may be available either through Internet access or elsewhere and advises the patient at 470 to seek further in-person evaluation from a health care provider. If there are matches, a further test is performed at 480 to ascertain whether the patient's should be treated as emergent. If so, the patient is directed to take the appropriate action at 490 which may be either presenting to an emergency treatment room for immediate treatment or contacting the health care provider on call for clarification. One purpose of the method of this invention is not to obviate the need for physician intervention by automating healthcare delivery, but rather to increase the efficiency and lower the cost of providing health care. If a word link does exist, based on either the patient selected medical problem and its diagnostic template link(s) or on word links from the patient's description of a complaint, a standard diagnostic template is provisionally selected at 500 and linked to the one or more blank medical projects created for that patient. It should be noted that at any point during the method described herein, the patient may be directed to relevant educational materials for the purpose of increasing patient understanding of how a condition is typically approached and compliance with a treatment process and to improve patient satisfaction.

At this point, a physician accesses the staff view through the PMI at 510 to retrieve and view all of the data concerning this particular medical project as well as a comprehensive history of the patient. The PMI then allocates or reallocates health and administrative resources at 515 according to the requirements of processes specified by the one or more diagnostic templates linked to this medical project. The next process called for by the diagnostic template is executed at 517. The information collected is presented to the physician at 520 in order to guide the physician in forming a differential diagnosis and for confirmation that the provisionally selected diagnostic template(s) are appropriate. While making a differential diagnosis, the physician can add or remove one or more diagnoses from those applicable to a particular patient and, by doing so, can alter or delete the provisional templates linked to that patient and, hence, the diagnostic process for that patient. Properly authorized staff may also add, modify or delete diagnostic templates. For example, a nurse would be able to initiate a diagnostic process on a patient when the patient presents and may gather data by scheduling certain lab tests related to the condition to make certain preliminary assessments prior to physician review. Such flexible management of a differential diagnosis within the overall diagnostic process is an important feature of this invention. If the physician deems that more information is needed at 530 during the course of reviewing the patient-related data entered either directly by the patient, by the nursing staff or by another physician or as the result of any tests, such may be requested at 540, and the appropriate resources are then allocated at 510. If the physician concludes he cannot reach a final diagnosis at 550, a referral to a specialist or other health care provider is made at 560. Once the physician can make a final diagnosis at 550, the appropriate diagnostic template or templates from the second database are finally linked to the patient's complaint and to the one or more blank medical projects created for that patient in the seventh database. Any or all of these templates may be changed in real time as the physician deems necessary at 570. However, each diagnostic template is assigned a level of stringency governing the extent to which physicians or others are able to alter the process or processes comprising that template. The level of stringency can be variable depending on the nature of the medical condition, the type of change or the task involved. For each element or item type there is a property that identifies if and to what extent the item can be altered and if those parameters are exceeded, the item/project is flagged. Default values for this property are also dependent on the project. A global default function is established so that all the items within that project are set at a certain default level. Item properties can also be set individually. This provides a method for measuring patient compliance and associating this data with outcomes. Statistical variation within templates can also be measured by looking at items within the template. If the variation exceeds a certain, pre-specified threshold, as determined at 580, then that project is flagged for review and approval at 590 by referral to the staff view module of the PMI at 330. If an item is changed outside of pre-specified range limits determined to be acceptable, it is also flagged at 590, the user is notified, and a basis or rationale for that change may be required. Such review may result in either permanent amendment of the process template itself in the second database to reflect an improvement, or the physician may be advised that the change was inappropriate. Such a change in the template could be effective system wide and thereby change the course of treatment and diagnosis, as relevant, for all patients linked to that template. In individual cases, however, the health care provider can also override such global changes. Regardless, the patient view, accessible through the PMI, always provides the patient with a real time link to the currently effective course of diagnosis and eventual treatment for that individual patient. This continual patient access possibility to diagnostic and treatment projects increases patient compliance and, hence, eventual likely success. Also, this arrangement allows the patient to take on a more proactive role and have more confidence in the care received. The finally linked templates govern further patient diagnostic and subsequent treatment activities including requesting yet further data, scheduling office appointments and laboratory workups and scheduling referrals, where needed. The diagnostic template relating to each medical project in the seventh database is saved at 600 for future reference, as needed. The medical project now enters the treatment process.

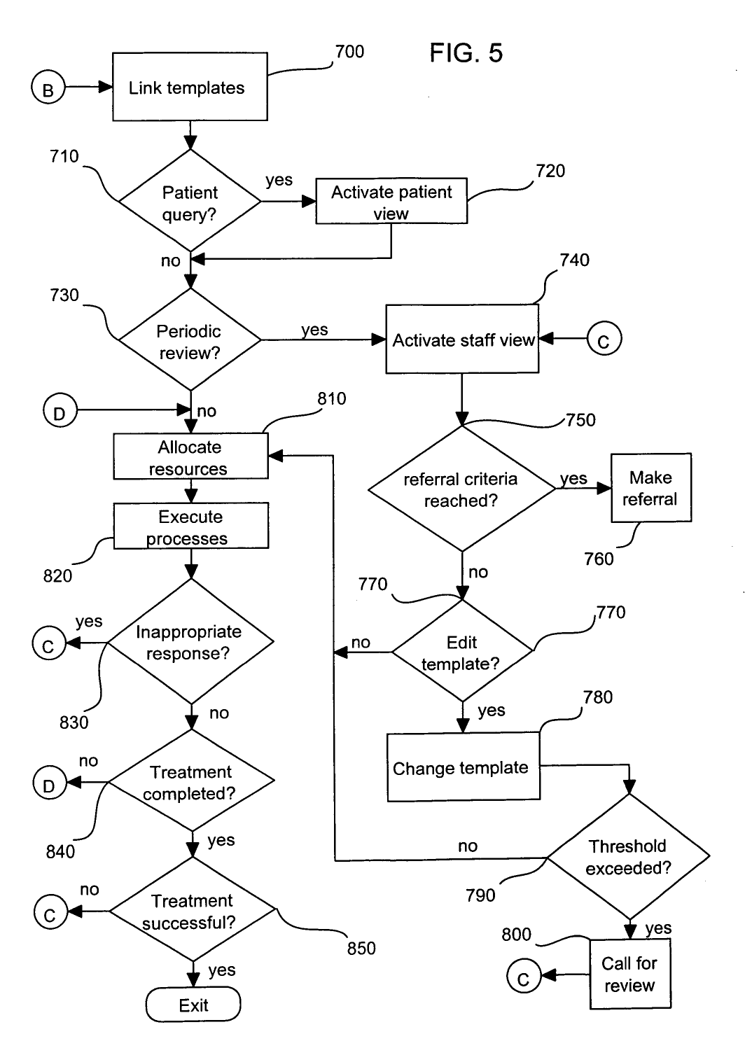

FIG. 5 illustrates in block diagram form the treatment process of 60. Once one or more final diagnoses of one or more conditions has been confirmed by a physician or other authorized health care provider, the PMI automatically selects one or more appropriate treatment templates from the fifth database for each diagnosis and provisionally links it to the one or more medical projects for this patient in the seventh database at 700. If none is appropriate, one or more blank treatment templates from the sixth database are selected and linked to the medical project for this patient in the seventh database. If a patient desires to obtain treatment information at 710, the patient view of the PMI is accessed at 720. The patient view enables a patient to access either remotely over the Internet or through a terminal at a health care facility or elsewhere the treatment template linked to his/her medical project. This patient view provides an historical view of the treatment process as well as expected future treatment, future assessment points and expected outcomes or goals of a particular therapy. Furthermore, the patient can access educational materials both through Internet hyperlinks and within the health care facility through links provided through the patient view. Alternatively, a patient may visit the health care facility and receive oral instructions from the nursing staff at the health care provider concerning the treatment process set out in the treatment template. The status and progress of all active treatment templates is periodically reviewed on either an elective or mandated time schedule at 730 to ascertain compliance and other quality measures. In the case of a blank treatment template, review is mandatory throughout treatment since the physician must continuously edit the template, as described in connection with block 770 below. If there are items which have not been timely completed, the PMI would flag those items so that appropriate disposition can be arranged and documented. The appropriate and properly authorized staff person would be notified automatically by the PMI in the staff view at 740 if an item has not been completed. All medical projects are password protected for security. A comprehensive view of the data collected and future planned assessments along with the history of patient care activities and planned future activities related to the treatment template are provided in the staff view. In addition, a physician or other authorized persons may confirm that the one or more provisionally selected treatment templates linked to a patient are appropriate. From within the staff view, a decision can be made at 750 whether criteria exist warranting a referral to another health care provider, facility, specialist or service. Various criteria can be established that would trigger a referral or suggestion that a referral is made. One such example would be when a treatment goal is not achieved, such as in hypertension. If the patient's blood pressure has not met a certain goal within a specified period of time despite adequate titration of medications, the system would suggest referral. Another example would be if a certain severity of disease is reached warranting referral. An example would be in renal disease. If the patient's creatinine clearance (a measure of renal function) deteriorates to a certain level then the system would suggest referral. Similarly, diagnostic processes can have referral criteria. If a diagnosis is not made within a certain period of time then a referral can be suggested. Other criteria can be established. These criteria are customizable by the individual practitioners according to their practice patterns but can be monitored as a part of the overall process management structure. If the relevant criteria do exist, a referral is made at 760 and, if not, a further decision is required at 770 whether the treatment template should be amended. Any properly authorized person accessing the staff view may edit patient care in real time by entering changes in the one or more treatment templates at 780 which add, delete or modify events and the timing of events appearing in that template. Each treatment template/process is assigned a level of stringency governing the extent to which physicians or others are able to alter the process. The level of stringency can be variable depending on the nature of the medical condition, the type of change or the task involved. For each element or item type there is a property that identifies if and to what extent the item can be altered and if those parameters are exceeded, the item/project is flagged. Default values for this property are also dependent on the project. A global default function is established so that all the items within that project are set at a certain default level. Item properties can also be set individually. This provides a method for measuring patient compliance and associating this data with outcomes. Statistical variation within templates can also be measured by looking at items within the template. If the variation exceeds a certain threshold, as determined at 790, then that project is flagged for review at 800. If an item is changed outside limits determined to be acceptable, it is also flagged, the user is notified, and a basis or rationale for that change may be required. Such review may result in either permanent amendment of the treatment template itself in the fifth database to reflect an improvement which should be applied globally, amendment of the treatment template linked to specified medical projects in the seventh database or the physician may be advised that the change was inappropriate. Such a change in the template could be effective system wide and thereby change the course of treatment and diagnosis, as relevant, for all patients linked to that template. In individual cases, however, the health care provider can also override such global changes. In either case, the PMI then automatically coordinates, allocates and reallocates resources, as needed, at 810, as described above, and execution of treatment processes specified by the treatment template is resumed at 820. Similarly, if a decision is made at 770 not to edit the template, treatment pursuant to the treatment template is also resumed at 820. As treatment progresses, direct patient observations as recorded in the PMI or entries made in the patient view of the PMI may indicate at 830 that the patient is having an inappropriate response to the treatment specified by the treatment template, such as suffering an undesirable side effect to therapy or experiencing a complication. In such cases, the PMI automatically calls for an immediate physician intervention in the staff view by returning to 740. If none of the foregoing occurs, the treatment plan called for by the template is resumed. After each event in the treatment plan is completed, the PMI initiates a query at 840 whether the events in the one or more treatment templates associated with that patient have been completed. If not, the PMI returns to 820 to execute the next event in the process of the relevant template. If the events in the treatment template have all been completed, either the PMI or the physician, as desired, assesses at 850 whether the treatment has been successfully completed depending on the type of condition being addressed. The treatment process for any particular treatment template ends either if the condition is an acute one which has been resolved by treatment or if it is chronic and may be further treated through chronic management. If treatment is not successful, the staff view is activated again at 740 with a call for physician intervention.

In the traditional electronic medical record system, the method of data collection and billing and thus the medical record itself determines patient care. In the method of this invention, patient care delivery is made independent of data management by separating what was done from how it is done. The process management system of this invention incorporates multi-threaded process management technology and will monitor what data is collected, the care delivered and provide physician decision support not currently available. However, the process management system will not dictate how care is delivered. Consequently, providers will be enabled to create new methods by which patients can be assessed and treated while at the same time monitoring the quality of care delivered. Furthermore, by managing patient treatment in this manner, the need for physician encounter notes is eliminated while at the same time full treatment documentation together with a less time intensive and more effective level of patient care is automatically achieved. Since all data relating to any medical project, which may incorporate multiple diagnoses and treatments, is collected and made accessible through the PMI, multiple different staff and/or providers can manage and/or input data simultaneously. Finally, metrics are monitored over the entire health system encompassed by the PMI which can be as small as an individual clinic or as large as an entire health maintenance organization so that process effectiveness for individual treatments and throughout the system can be evaluated and clinical information regarding specific treatments and diseases can be collected and made easily retrievable to all users authorized to access the staff view of the PMI. The method of this invention enables statistical analyses of diagnoses and treatments thereby also permitting comparisons of their effectiveness between and within specific diseases as well as with known established medical projects. The method allows for analyzing trend changes that are occurring when medical projects are executed to look for variations which may help to improve healthcare delivery. Consequently, use of the method results in continual quality improvement in the core medical processes of care, diagnosis and treatment. The method of this invention may also be applied to multiple care environments including, but not limited to, outpatient clinics, hospitals and acute care facilities as well as larger populations such as health maintenance organizations.

The process steps disclosed herein are not the only way in which the method of this invention can be implemented. Other embodiments and sequences of steps are possible so long as the overall functions and advantages described above are preserved.

What is claimed is:

1. An interactive, computer-assisted method for collecting, organizing, supervising and analyzing data concerning medical care of at least one patient having at least one health complaint related to a known set of diseases and health conditions involving diagnoses, treatments and health facility resource management related to at least one medical project associated with each such patient, wherein diagnosis depends on the results of executing at least one process described in at least one diagnostic template and treatment is accomplished by executing at least one process described in at least one treatment template, comprising
creating a plurality of diagnostic templates, each including at least one process and each leading to a diagnosis of at least one disease or medical condition from the known set of diseases and medical conditions;
storing the diagnostic templates in at least one database;
further creating a plurality of treatment templates, each including at least one process and each associated with treatment of at least one disease or medical condition from the known set of diseases and medical conditions;
further storing the treatment templates in at least one other database;
at least one patient presenting with at least one health complaint;
initiating at least one medical project associated with each patient;
collecting and storing identification, historical and demographic data concerning each patient in at least one database;
associating the at least one health complaint with at least one of the diagnostic templates;
linking at least one of the diagnostic templates with the at least one medical project associated with that patient;
establishing at least one diagnosis for the at least one patient related to the at least one health complaint of the at least one patient by completing the at least one process specified in the at least one diagnostic template linked with the at least one medical project associated with the at least one patient;
selecting at least one of the stored treatment templates associated with the at least one diagnosis related to the at least one patient;
further linking the at least one selected treatment template with the at least one medical project associated with the at least one patient; and
treating each patient according to the at least one process presented in the at least one selected treatment template linked to that patient's at least one medical project until either all of the patient's complaints are resolved, all of the patient's complaints have evolved into manageable chronic conditions or a need to refer the patient elsewhere for one or more of the complaints is determined.

2. The method of claim 1 wherein creating further comprises:
assembling medical diagnoses in a first database;
identifying processes for each diagnosis;
further associating at least one process with each diagnosis; and
converting all processes associated with the same diagnosis into a diagnostic template.

3. The method of claim 2 wherein storing further comprises
storing each diagnostic template in a second database;
indexing the processes;
storing the resulting index in a third database; and
establishing a fourth database containing blank diagnostic templates.

4. The method of claim 1 wherein further creating further comprises;
further identifying all treatment processes related to each diagnosis;
further converting all treatment processes related to the same diagnosis into a separate treatment template associated with that diagnosis.

5. The method of claim 4 wherein further storing further comprises:
populating a fifth database with each said treatment template; and
making a sixth database containing blank treatment templates.

6. The method of claim 1 wherein initiating further comprises:
further establishing a seventh database for containing and organizing all medical projects related to all patients; and
integrating all of said databases with software for controlling, editing, analyzing and supervising all data in all of said databases.

7. The method of claim 6 wherein integrating further comprises further establishing:
a database module for storing all of said databases;
a patient view module for enabling patients to securely access and view data stored in said seventh database;
a decision points monitoring module for prompting actions by specified persons at pre-designated points where required by any diagnostic or treatment template;
a resource allocation module for automatically coordinating, scheduling and allocating medical resources according to entries made in the respective diagnostic or treatment template for a medical project and notifying affected parties of scheduling or rescheduling of events and for performing administrative functions;
a process evaluation module for analyzing the implementation, effectiveness and outcome of processes called for by each active version of a diagnostic or treatment template;
a template configuration management module for performing version control of diagnostic and treatment templates;
a deviation monitoring module for supervising any deviations from processes otherwise mandated by one or more diagnostic or treatment templates; and
a staff view module for enabling authorized persons to access, view, analyze and edit data in all of said other modules.

8. The method of claim 1 wherein presenting can occur electronically or in-person.

9. The method of claim 3 wherein associating further comprises for each health complaint any one of:
allowing the patient to select a listed medical complaint which is already linked to a diagnostic template in said second database;
activating a blank diagnostic template from said fourth database into which the patient enters a textual description in words and phrases describing the one or more complaints after which a search of the index in said third database is performed in order, if a match is found, to provisionally link one or more known diagnoses to the complaints of the patient to one or more related diagnostic templates from said second database; or
referring the patient for an in-person consultation with a health care provider.

10. The method of claim 9 wherein, if one or more diagnostic templates has been provisionally linked to one or more diagnoses, associating still further comprises:
referring the medical project to a physician;
allocating health and administrative resources, as necessary;
executing the next process called for by one or more diagnostic templates;
forming of a differential diagnosis by the physician;
obtaining additional data, if needed;
confirming, adding and deleting one or more diagnoses linked to the patient, as appropriate;
ascertaining if one or more final diagnoses can be made;
further linking the one or more final diagnoses to one or more diagnostic templates from said second database; and
still further linking of the one or more diagnostic templates to the one or more medical projects in said seventh database; and
if no diagnosis can be made, referring the patient elsewhere.

11. The method of claim 10 wherein, after further linking, the method comprises:
modifying one or more diagnostic templates;
reviewing the modification to determine if a pre-specified threshold or range limit has been exceeded;
if the threshold or limit has been exceeded, obtaining physician review and approval of the modification;
if a modification has been approved and a corresponding election has been made, permanently adopting the modification by altering the corresponding diagnostic template in said second database or adding a new diagnostic template to said second database, as needed; and
returning to allocating.

12. The method of claim 1 further comprising enabling each patient to electronically access all medical projects related to that patient.

13. The method of claim 1 wherein treating further comprises:
allocating health and administrative resources, as necessary;
executing each process called for by the one or more treatment templates linked to the patient;
periodically reviewing the status of each such active treatment template linked to each patient for timely completion, quality and compliance;
providing electronic notification if an item in the treatment template fails to meet periodic review standards;
referring the patient elsewhere for treatment if criteria exist warranting such referral;
returning to allocating until an inappropriate response in the patient occurs, all processes in the one or more treatment templates are complete or the one or more treatment templates are deemed unsuccessful, wherein
in the case of an inappropriate response or an unsuccessful treatment, physician intervention occurs.

14. The method of claim 13 wherein, after referring, the method further comprises:
deciding whether to continue treatment as specified by said active treatment templates or to modify one or more of said active treatment templates;
if treatment continuation is decided upon, returning to executing;
if modification is decided upon, reviewing the modification to determine if a pre-specified threshold or range limit has been exceeded and, if so, obtaining physician review and approval of the modification;
if a modification has been approved, amending the relevant treatment template linked to the medical project for the patient in the seventh database; and
if a corresponding election has been made, permanently adopting the modification by altering the corresponding treatment template in said fifth database.

15. The method of claim 1 wherein processes within templates are comprised of an interlinked series of events including activities, questions, instructions, pre-designated decision points, actual data and requests for data.

16. The method of claim 1 wherein computer data is entered by means of one or more of dictated notes, standard word document formats including, but not limited to, .pdf, .doc and .ect, audio recordings, digital photographs in multiple formats, real time input from medical devices such as stethoscopes, electronic EKG's, digital radiographs and video recordings.

17. The method of claim 1 further comprising enabling each patient to access all data in all medical projects linked to said patient through a password protected, Internet-accessible account.

18. The method of claim 1 further comprising permitting properly authorized persons to view any stored data either on a single patient, multi-patient, medical project or global basis.

19. The method of claim 1 further comprising permitting properly authorized persons to view any stored data on either a single process, multi-process, single template or multi-template basis.

20. The method of claim 10 further comprising electively allocating health and administrative resources on an individual patient, multi-patient, process or global scale.

21. The method of claim 13 further comprising electively allocating health and administrative resources on an individual patient, multi-patient, process or global scale.

22. The method of claim 10 further comprising electively displaying data to an authorized person as it relates to one or more processes or as it relates to data type, as preferred.

23. The method of claim 13 further comprising electively displaying data to an authorized person as it relates to one or more processes or as it relates to data type, as preferred.

24. An interactive, computer-assisted method for diagnosing in at least one patient at least one condition from a known set of diseases and medical conditions, wherein each patient has at least one medical complaint associated with at least one medical project for that patient and wherein further the diagnosis depends on the results of executing at least one process described in at least one diagnostic template, comprising
creating a plurality of diagnostic templates, each including at least one process and each leading to a diagnosis of at least one disease or medical condition from the known set of diseases and medical conditions;
storing said diagnostic templates in at least one database;
at least one patient presenting with at least one health complaint;
associating said at least one health complaint with at least one of said diagnostic templates from said first database;
linking said at least one associated diagnostic template with the at least one medical project associated with said patient; and
establishing at least one diagnosis for each of said patients related to said at least one health complaint of each of said patients by completing the processes specified in the at least one diagnostic template linked with the at least one medical project associated with each of said patients.

25. The method of claim 24 wherein creating further comprises:
assembling medical diagnoses in a first database;
identifying processes for each diagnosis;
further associating at least one process with each diagnosis; and
converting all processes associated with a diagnosis into a diagnostic template.

26. The method of claim 25 wherein storing further comprises
storing each diagnostic template in a second database;
indexing the diagnostic processes;
storing the resulting index in a third database; and
establishing a fourth database containing blank diagnostic templates.

27. An interactive, computer-assisted method for treating at least one diagnosed disease or health condition from a known set of diseases and medical conditions in at least one patient presenting with at least one complaint, wherein at least one diagnosis for each patient is associated with at least one medical project for that patient and wherein further treatment is accomplished by executing at least one process described in at least one treatment template, comprising
creating a plurality of treatment templates, each including at least one process and each associated with treatment of at least one disease or medical condition from the known set of diseases and medical conditions;
storing the treatment templates in at least one database;
selecting at least one of said stored treatment templates associated with each diagnosis related to the at least one patient;
linking said at least one selected treatment template to the at least one medical project associated with the at least one patient; and
treating each patient according to the processes included in said at least one selected treatment template linked to that patient's at least one medical project until either all of the patient's complaints are resolved, all of the patient complaints have evolved into manageable chronic conditions or a need to refer the patient elsewhere for one or more of the complaints is determined.

28. The method of claim 27 wherein creating further comprises;
identifying all treatment processes related to each diagnosis;
converting all treatment processes related to the same diagnosis into a separate treatment template associated with that diagnosis.

29. The method of claim 27 wherein storing further comprises:
populating a designated database with each said treatment template; and
making an additional database containing blank treatment templates.

30. The method of claim 27 wherein treating further comprises:
allocating health and administrative resources, as necessary;
executing each process called for by the one or more treatment templates linked to the patient;
periodically reviewing the status of each such active treatment template linked to each patient for timely completion, quality and compliance;
providing electronic notification if an item in the treatment template fails to meet periodic review standards;
referring the patient elsewhere for treatment if criteria exist warranting such referral;
returning to allocating until an inappropriate response in the patient occurs, all processes in the one or more treatment templates are complete or the one or more treatment templates are deemed unsuccessful, wherein in the case of an inappropriate response or an unsuccessful treatment, physician intervention occurs.
